(19) United States
(12) Patent Application Publication
(10) Pub. No.: US 2006/0253722 A1
(43) Pub. Date: Nov. 9, 2006

(54) Uncopyable optical media through sector errors

(76) Inventors: Hans H. Nielsen, Santa Cruz, CA (US); Eric H. Nielsen, Santa Cruz, CA (US)

Correspondence Address: Eric H. Nielsen, 110 NANNA CT, SANTA CRUZ, CA, 95060, US

(21) Appl. No.: 11/112,019

(22) Filed: Apr. 21, 2005

(51) Int. Cl. G06F 11/00

(52) U.S. Cl. 714/1

(57) ABSTRACT

A method for inhibiting the copying of digital data digital content on optical media that enables unique marking of each copy. This invention encodes data in errors that inhibit copying. Errors are common on optical media, and error checking and correction data increase the size of digital data on a standard Compact Disk (CD) by 322%. For every read of an optical disk, the errors found vary read to read, and handling of the CD adds new errors. This makes the presence of errors unreliable. Most optical media readers cannot provide detailed error information in any case. In the first embodiment of this invention, errors cause entire sectors to be unreadable. With overwhelming errors written to a sector these sectors can be reliably detected as unreadable. The ability to read or not read specified sectors comprises the 1's and 0's of digital data. As part of extracting the data from the optical media, a program knows to look for these potentially bad sectors. Because optical media copiers are not designed to copy errors, this data is not generally copyable. A program can seek to be sure the original optical media is present at will. There are multiple manufacturing means that can be used to cause sectors to be errored in unique ways, enabling unique identities for each copy of the data. The unique data is then used as content for license key generation so that each copy of the media has a unique license key. Because no watermarking has occurred, the digital content being protected remains unaltered and error free.

### FIELD OF THE INVENTION

The present invention relates generally to optical media containing digital data typically associated with computer software. However it could also be applicable to video (e.g., movies) or audio data (e.g., music) typical of the entertainment industry. It applies specifically to restricting copying of optical media and restricting access to digital content by requiring presence of the optical media.

### BACKGROUND OF THE INVENTION

Physical CD-ROM Media

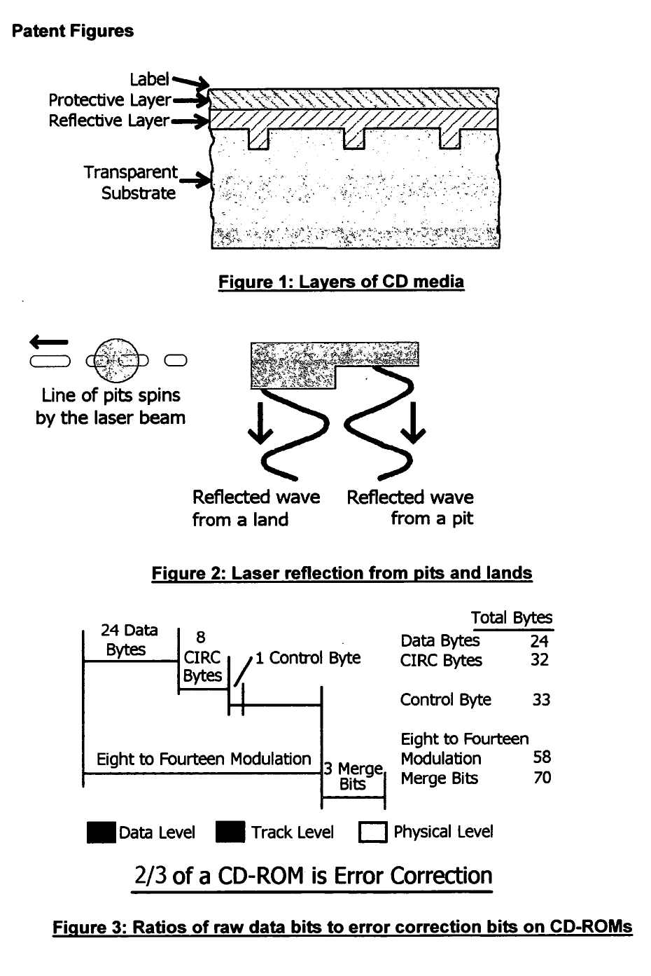

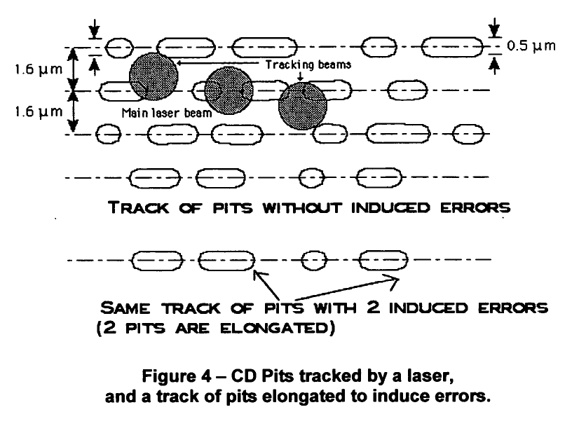

CD-ROMs are an optical medium, using lasers to store and read data. A CD is made up mainly of polycarbonate plastic. The bottom layer contains optical pits which are stamped into the CD-ROM. For a CD reader to read the data, a reflective layer above the polycarbonate is used to reflect the laser light back to the optical reader. This reflective layer is only a few microns thick, and if any damage is done to it, the data in that area can't be read. On top is a sturdy protective layer of plastic on which the label is printed. This is shown in FIG. 1.

Data is stored on a CD-ROM using pits and lands. The CD reader uses a laser on the 780 nm wavelength to determine the distance between the laser and the pit. The reader detects differences in depth by detecting changes in phase in the returned signal as shown in FIG. 2. The optical pit lengths are measured in T, which is a distance around 0.29 μm. Pits vary in length from 3 T-11 T. Any pit less than 3 T is too small to be accurately detected by the laser and pits longer that 11 T are too long to accurately read. Bytes of data are translated into optical pits using a technique known as Eight to Fourteen Modulation, or EFM, encoding. This takes 8 bits and turns it into a 14 bit code that can be written using these 3 T-11 T long pits.

CD-ROM Error Correction

CD-ROMs have massive amounts of error correction. All CD-ROMs have a low-level correction known as Cross-Interleave Reed-Solomon Coding, or CIRC. For every 24 bytes of data, 8 bytes of CIRC are added. Besides adding error correction, the order of the data is also scrambled in the process. This decreases the likelihood of losing data and error correction codes even with a large scratch. These 32 bytes are then grouped together with a signal byte into what is known as a frame. This is used on both data and audio CD-ROMs. Another type of error correction (Mode 1) is used on data CDs for an added level of data security. For every 2048 bytes of data, 276 extra bytes of CIRC encoding are used. This is a preventive measure to make sure the data can be read, reducing errors from 1 per hour to 1 per century with a read speed of 1×.

CD readers can report the errors detected when reading a CD-ROM. A basic quality test finds out how many errors are there and how serious they are. There are two designations for low-level error correction: C1 and C2 errors. C1 errors are common even on a new CD. A block error rate (BLER) of 5 C1 errors per frame is typical. This is an example of why error correction is necessary. Very few CD readers are able to report C1 errors, so using this as a detection mechanism is something that would not work with most CD readers. The amount of C1 errors is used to determine whether the next level of error correction, C2, is necessary. FIG. 3 depicts the ratio of raw data bits written to a CD compared to error correction bits.

C2 errors are a much more serious occurrence. The CD-ROM standard specifies that no pressed CD should have any C2 errors right after it has been manufactured. One C2 error means at least 28 of the least destructive C1 errors exist. If there are more than 2 C2 per frame, the frame cannot be corrected and is then passed, uncorrected, to the computer for Mode 1 error correction. Seven or more consecutive uncorrectable frames mean a failure of the entire data sector, which is 98 frames long.

CD-ROM Copy Protection Solutions

Many current solutions for copy protection already exist. All of them involve some kind of media peculiarity on the CD-ROM which the copy protection program checks for and that confuse CD copiers. One new method uses duplicated ranges of sectors so that reading the CD-ROM in one direction will get different data than it would if it read in the other direction. Because of these duplicated sectors, this method is not standards-compliant. Another newer method uses duplicated sectors rather than sector ranges. Throughout the CD there are duplicated sectors which cause the CD reader to read slower. The copy protection can detect this, and fails if the CD reads too fast. This method also violates the CD-ROM standard because it uses duplicated sectors.

CD keys for mass-produced copy protection use a generation technique where multiple keys are able to unlock a copy of software. There are prerelease copy protections that have unique IDs burnt onto CD-Rs, but these are based on easily readable/copyable data on the CD.

As of the writing of this section, all of the current copy protections can be defeated. Most copy protections are tricks to fool a CD copier. For example, the latest version of SecuROM uses the “twin sectors” method described above. The duplicate sectors on a CD slow down the CD reader. Within a few weeks of the protection's release, a program was available that could read these twin sectors and burn them back to a CD, making the protection useless. Based on the experiences of copy protections to date, it will be difficult to create copy protections that cannot be broken quickly.

CD-ROM Unique Identifiers

Custom CD-Rs have been created which contain unique data. More recently (March 2004) Sony has started to write 32 bytes of unique data to mass produced CD-ROMs. Thus there are techniques known in industry to modify mass produced CDs post pressing to make them unique. These same techniques can be means to induce unique sector errors on optical media such as a CD.

Cryptography

Two cryptographic methods were used to guarantee software protection. The two publicly available encryption techniques used are secure hashing and public/private key cryptography.

The SHA-1 secure hash takes input data and forms it into a 160-bit output. Because it is a secure hash, the input cannot be determined from the output. The input cannot be guessed, either, as there are 2¹⁶⁰, or 1,461,501,637,330,902,918,203,684,832,716,283, 019,655,932,542,976 possible outputs. This would take the fastest computer in the world years to determine the input. SHA-1 was chosen as an algorithm because it is the current federal secure hash standard. It should also have a 1 to 1 input to output ratio, meaning two unique inputs will not form the same output.

Public/private key encryption is used to verify both identity and data safety. Private keys are encryption keys that are kept secret by the owner. The public key is generated from the private key using a non-reversible function. Since the public key is distributed freely, this prevents someone with the public key from determining the private key. When the public key is used to encrypt data, only the private key can decrypt the data. This prevents unauthorized persons from looking at the data. When the private key is used to encrypt the data, anyone with the public key can decrypt it. While the data is not secured, the origin of the data is verified because only one unique origin has the necessary private key. RSA was chosen as the algorithm because it is widely available and complies with current federal security standards.

### REFERENCES

“CD/DVD Protections”. CD Media World. <http://www.cdmediaworld.com/hardware/cdrom/cd_protections.shtml>
“Club CD Freaks Discussion Board”. CD Freaks. <http://club.cdfreaks.com/>
Chip Chapin. “Chip's CD Media Resource Center”<http://www.chipchapin.com/CDMedia/>
Professor Kelin J Kuhn. “Audio Compact Disk—An Introduction 95×6”. University of Washington. <http://www.ee.washington.edu/conselec/CE/kuhn/cdaudio/95×6.htm>
Professor Kelin J Kuhn. “Audio Compact Disk—Writing and Reading the data 95×7”. University of Washington. <http://www.ee.washington.edu/conselec/CE/kuhn/cdaudio2/95×7.htm>
Professor Kelin J Kuhn. “CD/ROM—An extension of the CD audio standard 95×8”. University of Washington. <hftp://www.ee.washington.edu/conselec/CE/kuhn/cdrom/95×8.htm>
Ron Roberts. “SCSI Multimedia Commands-2 (MMC-2) T10/1228-D”. National Committee on Interface Technology Standards Technical Committee T10. <http://www.t10.org/ftp/t10/drafts/mmc2/mmc2r11a.pdf>
SirDavidGuy. “SirDavidGuy's Page of Technical CD Misinformation”. <http://sirdavidguy.coolfreepages.com/>
[ECMA130] “Standard ECMA-130”. ECMA International. <http://www.ecma-international.org/publications/files/ECMA-ST/Ecma-130.pdf>
[IEC 908] United States. National Institute for Standards and Technology Computer Security Resource Center. Federal Information Processing Standard 140-2 Security Requirements for Cryptographic Modules. <http://csrc.nist.gov/publications/fips/fips140-2/fips1402.pdf>
[FIPS 180] United States. National Institute for Standards and Technology Computer Security Resource Center. Federal Information Processing Standard 180-2 Secure Hash Standard (SHS). <http://csrc.nist.gov/publications/fips/fips180-2/fips180-2withchangenotice.pdf>
[MMC1] International Committee on Information Technology Standards. Committee T10. SCSI-3 Multimedia Commands (MMC). <http://www.t10.org/ftp/t10/drafts/mmc/mmc-r10a.pdf>
[MMC2] International Committee on Information Technology Standards. Committee T10. Multi-Media Commands-2 (MMC-2). <http://www.t10.org/ftp/t10/drafts/mmc2/mmc2r11a.pdf>
[MMC3] International Committee on Information Technology Standards. Committee T10. MultiMedia Command Set-3 (MMC-3). <http://www.t10.org/ftp/t10/drafts/mmc3/mmc3r10g.pdf>
United States. National Institute for Standards and Technology Computer Security Resource Center. Federal Information Processing Standard 186-2 Digital Signature Standard (DSS). http://csrc.nist.gov/publications/fips/fips186-2/fips186-2-change1.pdf

### Related Inventions

There are a number of inventions that have similar claims of limiting replication of optical disks containing software and other digital content. These other inventions will be compared to the invention claimed in this patent applications, called the “Uncopyable Optical Media through Sector Errors” invention.

The ability to correct for errors essential to reading and writing digital content onto optical media. U.S. Pat. No. 4,603,413 “Digital sum variance corrective scrambling in the compact digital disc system” is a solution to managing the media and random read errors.

U.S. Pat. No. 5,828,754 & No. 5,699,434 “Method of inhibiting copying of digital data” provide good background on understanding Digital Sum Variance (DSV) in optical and magnetic media. This patent protects data from copying by inserting weak sectors that are difficult to impossible to copy. The error generating data is inserted in with the digital content. Results of this will vary by the capabilities of the media writer, and the potential errors that are seen are random. In the “Uncopyable Optical Media through Sector Errors” invention data which may cause an error is not inserted within the digital content. Instead, whole sector errors are read consistently to produce data derived solely by the existence or absence of errors in a specified region.

U.S. Pat. No. 6,778,104 “Method and apparatus for performing DSV protection in an EFM/EFM+ encoding” discusses the use of convenient substitutions as a method to encode the digital content at a desired DSV. US Patent Application #20020076046 “Copy protection of optical discs” attempts to discover differences in higher than normal DSV valued data when read with high and low laser read intensities. None of the other inventions use errors to unambiguously represent data.

U.S. Pat. No. 6,694,023 “Method and apparatus for protecting copyright of digital recording medium and copyright protected digital recording medium” combines encryption and difficult to copy table references on the CD.

U.S. Pat. No. 6,780,564 “Methods and apparatus for rendering an optically encoded medium unreadable and tamper-resistant” as well as U.S. Pat. No. 6,709,802 “Methods and apparatus for rendering an optically encoded medium unreadable” are techniques to induce errors on a CD. The Uncopyable Digital Media through Sector Errors invention includes a method for inducing errors based on EFM encoding dynamics. Errors could be induced using this method as well, however additional controls are needed in the process to assure that some of the sectors effected by such a process are continue to track properly. Could such inventions be further enhanced to be used only on an identifiable subset of sectors, and then make a percentage of the sectors in this region of each mass produced optical disk individually randomly errored and unreadable? To be of use to the Uncopyable Digital Media through Sector Errors invention, the induced errors must not induce tracking problems, an attribute these other inventions have not yet demonstrated. These pit errors would then cause trackable sectors to show up as unreadable. The identity or order of the unreadable sectors would compose a unique identifier that is incorporated as part of the material used to create a unique authorization key to enable use of the software. These inventions have a further difficulty in that these random processes are not assured to cause errors that are read deterministically the same by most all Optical Media readers (e.g., CD and DVD drives) to be read repeatably, i.e. so that all readers identify the same sectors as unreadable. Additional enhancement is required to accompany these inventions so that tracking is not inhibited and only individual sectors are made unreadable.

U.S. Pat. No. 6,780,564 “Method of inhibiting copying of digital data” uses the technique of writing data using mastering techniques that potentially induces write errors when copying, and may induce read errors when reading. The technique exploits the weaknesses in EFM and EFM+ encoding that occur when the EFM encoding of data causes a high digital sum variance (DSV) which can be un-rewritable using commercial standard data writing techniques.

None of the Inventions below found induced errors in the data to inhibit the copying of Optical Media, or used data written as errors to determine authenticity of the Optical Media or the unique identity of the Optical Media.

US Patent Appl. #20010024411 “Copy-protected optical disk and protection process for such disk” requires the addition of a non-standard track within the space of another standard conforming track. Such disks vary from standards. The essential element is that the data read from a sector of a given label can vary based on whether the sector seek is in the forward or reverse direction. Unlike the claims made in the Uncopyable Digital Media through Sector Errors invention, there is no uniqueness of data characteristic mentioned in this patent. Also note that intelligent software/malware exists that circumvents this protection technique.

US Patent Appl. #20020057637 “Protecting A Digital Optical Disk Against Copying, By Providing A Zone Having Optical Properties That Are Modifiable While It Is Being Read” requires that the reflectivity of the CD pits dynamically change based on exposure to the laser. The Uncopyable Digital Media through Sector Errors invention requires no special materials or dynamically changing responses. Patent Appl. #20020093905 “CDROM Copy Protection” similarly depends on laser intensity to get alternative results when reading pits.

US Patent Appl. #20020159591 “The copy protection of digital audio compact discs” interferes with the readability of the content to assure copy protection. In the Uncopyable Digital Media through Sector Errors invention all content on the optical media is stored and read without any corruption or watermarking.

US Patent Appl. #20030046545 “Systems and methods for media authentication” requires that different results occur at different rates of data access. In the Uncopyable Digital Media through Sector Errors invention there is no dependence on rate of data access from the optical media.

US Patent Appl. #20030193858 “Apparatus and method for preparing modified data to prevent unauthorized reading/execution of original data” requires specialized driver interface to the CD-ROM. In the Uncopyable Digital Media through Sector Errors invention there is no dependence on the optical media reader.

U.S. Pat. No. 6,691,229 “Method and apparatus for rendering unauthorized copies of digital content traceable to authorized copies” is one of many fingerprinting type inventions to add uniqueness to a particular copy of content. In the Uncopyable Digital Media through Sector Errors invention there is fingerprinting mechanisms used to uniquely identify the digital content, only the accompanying errored sectors.

### Referenced Patents and Patent Applications

U.S. Pat. No. 6,780,564 “Methods and apparatus for rendering an optically encoded medium unreadable and tamper-resistant”
U.S. Pat. No. 6,709,802 “Methods and apparatus for rendering an optically encoded medium unreadable”
U.S. Pat. No. 6,691,229 “Method and apparatus for rendering unauthorized copies of digital content traceable to authorized copies”
US Patent Appl. #20010024411 “Copy-protected optical disk and protection process for such disk”
US Patent Appl. #20020057637 “Protecting A Digital Optical Disk Against Copying, By Providing A Zone Having Optical Properties That Are Modifiable While It Is Being Read”
Patent Appl. #20020093905 “CDROM Copy Protection”
US Patent Appl. #20020159591 “The copy protection of digital audio compact discs”
US Patent Appl. #20030046545 “Systems and methods for media authentication”
US Patent Appl. #20030193858 “Apparatus and method for preparing modified data to prevent unauthorized reading/execution of original data”
U.S. Pat. No. 5,828,754 & U.S. Pat. No. 5,699,434 Method of inhibiting copying of digital data
U.S. Pat. No. 4,603,413 Digital sum value corrective scrambling in the compact digital disc system
US Patent Appl #20020076046 Copy protection of optical discs
U.S. Pat. No. 6,694,023 Method and apparatus for protecting copyright of digital recording medium and copyright protected digital recording medium
U.S. Pat. No. 6,778,104 Method and apparatus for performing DSV protection in an EFM/EFM+ encoding
U.S. Pat. No. 6,691,229 Method and apparatus for rendering unauthorized copies of digital content traceable to authorized copies

### SUMMARY OF THE INVENTION

This invention solves the copy protection problem for software distribution. Today, the software isn't protected, but the software installation keys are. Sometimes software requires the original CD-ROM to be present. However, software keys can be stolen, shared, or generated, and CD-ROMs and DVDs will invariably be copied or the copy protect mechanism circumvented. The source of the copied software can't be traced as well.

This method is to insert deliberate errors on the software and data CD-ROMs that act to authenticate the optical media. The deliberate errors may be common to all CDs sharing the same content, or may be cause unique sequences of sector errors that can be used as an ID or validation key associated with each instance of optical media. And unlike other many copy protection solutions, this does not violate the CD-ROM standards.

CD distributed software can now provide extra protection. Using a cryptographic technique, this solution makes every copy of the software unique so each copy is linked to a single owner and key. No two copies of the software are alike. Because there is only one key valid for each copy of the software, typical key generation techniques can not break the protection.

For mass-produced CD-ROM distribution, induced errors are used to create uniqueness. These errors are constructed so that whole sectors on the CD Media are consistently unreadable by all CD readers. The reason that sector errors are used is that they are the only errors that are consistently reproducible on any CD reader. With extra care, these errors will also be read such that the optical readers can quickly determine that the media contains errors without requiring substantial real time to come to that conclusion.

There are multiple published methods that can be used to induce errors so that any CD reader can read detect these errors consistently. These errors are induced using high precision equipment. A focused ion beam machine could be used, Panasonic's Burst Cutting Area machine, or a masking technique that applies a coating that causes the CD to deteriorate areas where laser light is shined brightly. The errors induced can produce uniqueness, as in a serial number.

The method includes use of a program to read errored sectors from standard off-the-shelf the CD reader drives.

Optionally the method includes writing of individual or pairs of bad sectors by writing high DSV valued data onto individual sectors as a method of inducing errors to indicate errored sectors.

### DESCRIPTION OF AN EMBODIMENT OF THE INVENTION

First step is to determine a range of sectors upon which errors will be induced. For 256 bits of data, 256 sectors will be needed. Those familiar with the trade know how data CDs are laid out know how to locate a file on the CD so that the extent of said file include the 256 sectors to be used for data to be written whether a sector is readable or unreadable.

The first embodiment uses mass-production stamping or imaging methods. This method by nature can write “perfect” errors as well as write high DSV data (weak sectors) without difficulty as defined in claim 8. If a master is created in the normal way, it will need to be modified prior to use. The normal way involves EFM encoding and error correction algorithms that determine exactly what data to write on the CD.

Modification of the master can be performed on the data used to produce the physical master by modifying the C1 and C2 data to be inconsistent with the digital content within the sector and each other. Techniques to do this are known in industry. Alternative changes could be performed that do not cause tracking errors. The pit lengths in those sectors where errors are to be induced may be physically altered or pit to non-pit transitions smoothed. This may be random in nature, or may be more precise if a specific identifying data sequence is desired. The limitation is that induced data errors should not cause errors that cause the reading laser to loose track.

All CDs produced using the master CD will contain said uncopyable sectors. The number of independent bit level errors (i.e., an individual pit length error) required to make a sector unreadable is 588. A sector contains 98 frames of data. Seven or more consecutive erroneous frames of data will cause an entire mode 1 sector to be unreadable. To cause a frame to be returned erroneous it must have 3 or more “C2” errors. One C2 error means at least 28 of the least destructive C1 “bit” errors exist. If there are more than 2 C2 errors per frame, the frame cannot be corrected and is then passed, uncorrected, to the computer for Mode 1 error correction. Seven or more consecutive uncorrectable frames mean a failure of the entire data sector. It is recommended that the minimum number of errors be exceeded for assured identification of a sector with induced errors.

The errored sectors are located wholly within the area on the disk where a particular file resides. The potentially errored sector numbers are calculated prior to altering the master image. If the mastering process allows, the image master data can be altered so that the errors are already built into the image before creating the master, thus avoiding post processing of the master.

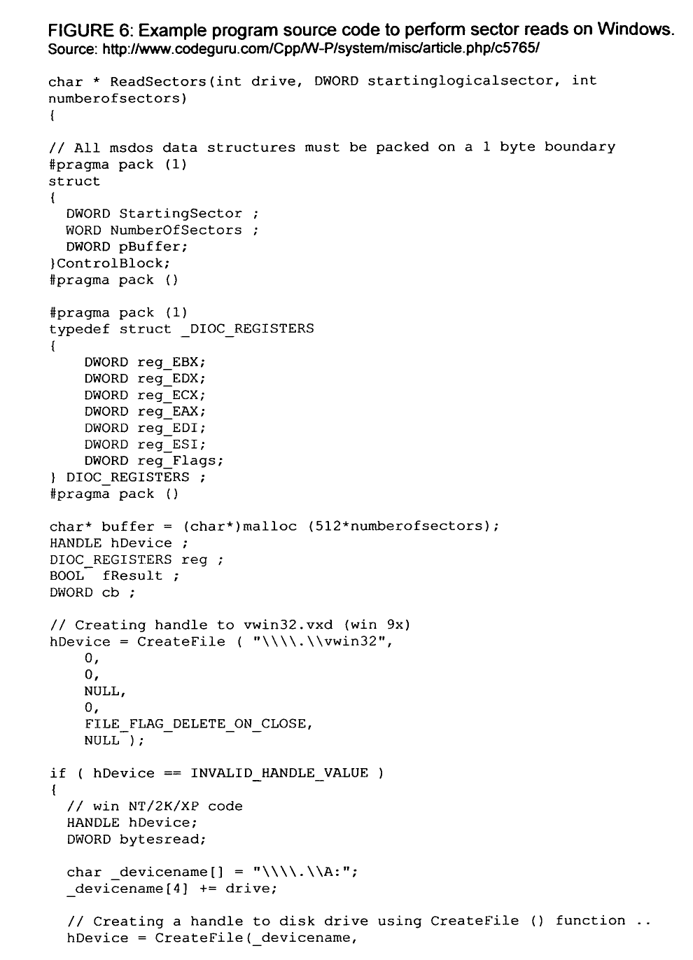

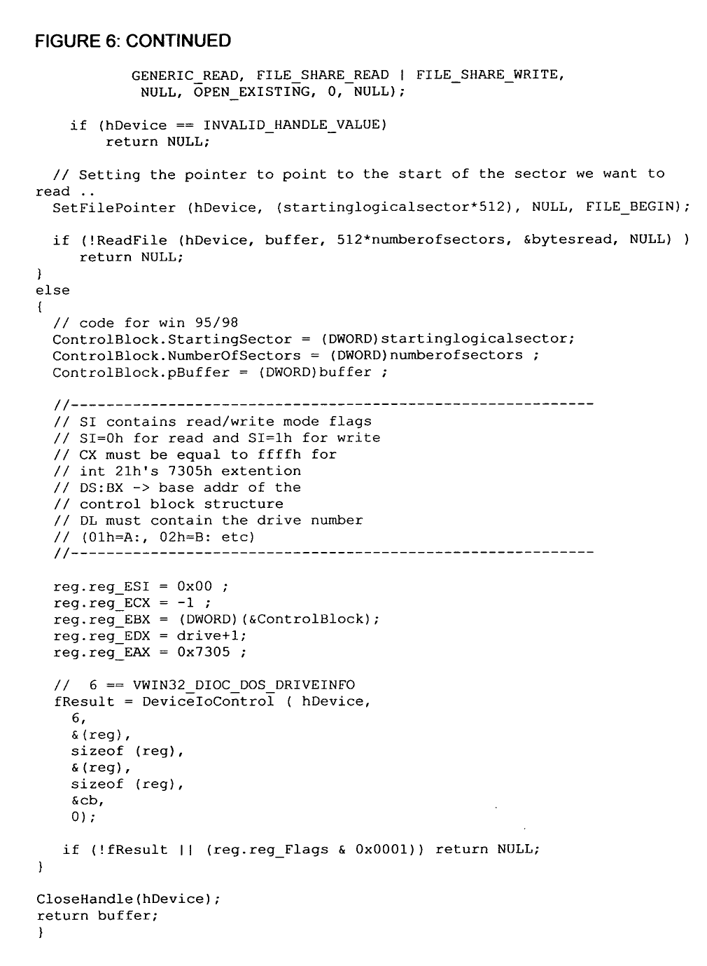

The content to be written on said CD is packaged as an executable. Within that executable are archive files including the file containing the potentially errored sectors. The contents may also be encrypted. The executable will control the CD reader so that it will perform sector reads on the area within said file. An example of one of many publicly available programs that perform sector reads is provided in FIG. 6. The results of the said sector reads will provide the 1's and 0's for the identification of said CD.

Said CD Identification Data is then authenticated. This could be a simple checksum against a stored value. In the situation where all CDs are the same, the data on the CD could be the symmetric key needed to decrypt the content on the CD.

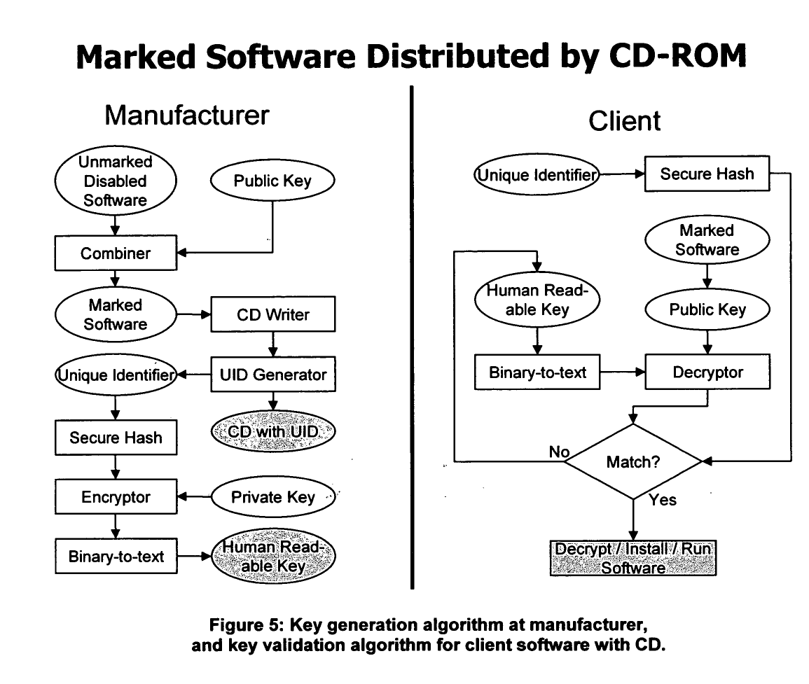

Once authenticated, the executable will make the content available for use. In this case it would be pulled out of the encrypted archive, likely as part of an installation process. The encryption process is described in FIG. 5.

Once the content is installed, a program can be used to guard access to the content. In this case to run an installed program it will first use the sector reading program embedded in said executable to validate that the original CD is available to the machine. The decryption process is described in FIG. 5.

A second embodiment alters the first embodiment of such standard mass produced CD after it is produced. This embodiment parallels the first process of creating the embodiment except that the master CD is not errored. A post production process is used to induce errors to produce errors on specified sectors. SONY DADC has proprietary means to do this process, as was announced in March 2004. Panasonic BCA has similar capabilities. Use of the milling capability of a focussed ion beam machine could produce the same result, though not in a way that is economically viable. In this embodiment the sector errors induced can be chosen to be unique to the instance of the optical media.

It is expected that lower cost mechanisms will be developed to do this process since the precision required to induce sector errors is much lower than that of writing data.

A third embodiment has induced errors created by a CD writer with a bad EFM merge bit calculator. These CD writers are unable to correctly write high DSV valued sectors (also known as weak sectors). In order to write a set of 256 sectors where, for example, particular sectors are unreadable, a file must be created that contains at least 257 sectors. Each sector contains a specific data sequence 2048 bytes long, the length of a sector. Two sequences are used. The first data sequence contains random, readable data. The second data sequence contains data that causes the merge bit calculator to malfunction, such as the hexadecimal number 0x659A repeated throughout the 2048 byte long sector. At the end of the file, a low DSV sector must be added as padding so that the weak sectors preceding it do not affect data integrity of other files. CD writers vary. For the best results on the CD writer in use some experimentation is required. Using values with lower DSV may work better on some writers than others. To vary the data written to disk the content of the sectors will be varied.

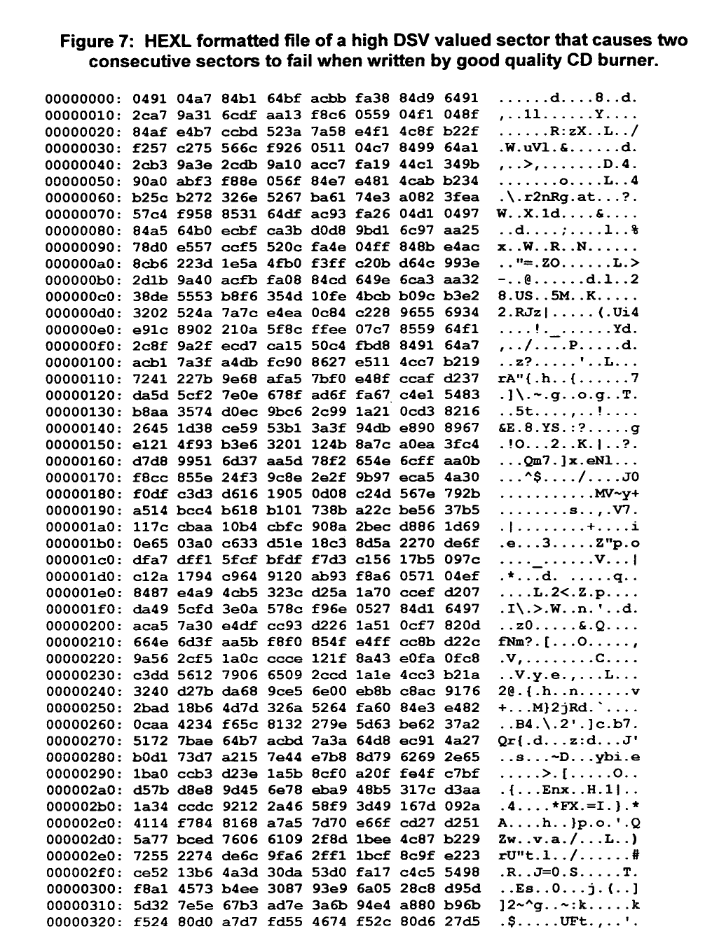

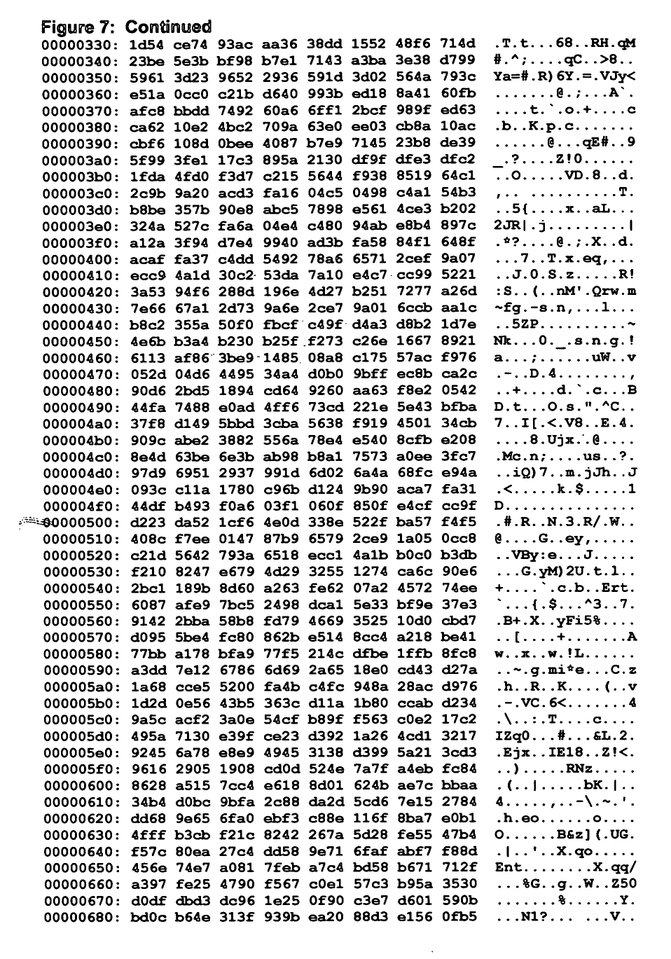

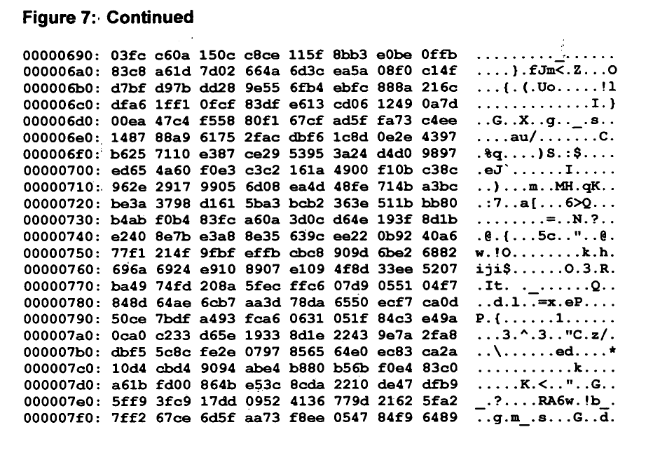

FIG. 7 is a HEXL format presentation of sector data that produces a very high DSV and causes persistent and consistent sector read errors.

In this case CD writing occurs based on an image onto a CD-R or other writable optical media. Part of the process of writing to the CD will include writing these spcialized sectors in a non-standard way.

Extentions

Combination of this invention with High DSV readable sectors will protect the CD from more advanced attempts to copy said CD because of the care needed to write alternate sectors with high and low laser strength.

This method will be extended to a plurality physical media where causing consistent applications-readable sector level errors will result. This will be due to inducing low level errors for the purpose of writing persistent data to the media that is generally not copiable. The writing of data to that physical medium must comprise a special encoding and padding of digital data (like EFM encoding) for robustness against errors, and some sector level error correction. The technique is to cause enough errors that the checksums cannot resolve the apparent physical layer errors so that reading the sector reliably gives a sector error. Such errored media is typically not copyable.

The coupling of this uncopyable data with various techniques with cryptographic mechanisms, such as signing the digital content. Using asymmetric key techniques a two-part key can be defined that requires the unique data on the optical media as well as a license key supplied by some other means, such as a human enters the key data in response to a query from the CD unpacking program. FIG. 5 outlines the process for performing this.

Encrypted Keying Technique for Use With Said Uncopiable Optical CD

Claim 9 is a specific technique for creating a one-to-one mapping between said CD's unique data and a unique key that is used to validate the owner of the CD. The algorithm used is shown in figure (X). An algorithm was developed to make the unique key based on a unique ID. This technique makes the generation of additional keys impossible by unauthorized parties.

The key is generated at the factory. When the unique ID is first read, a secure hash is taken using the SHA-1 algorithm as specified in [FIPS 180]. The hash is then encrypted using RSA encryption using a 1024 bit length private key known only to the manufacturer. The resulting encrypted data is then translated into a representation that is easily entered by the user. This data is the user key. All the code required for these transformations are publicly available using OpenSSL [OpenSSL].

To validate a CD, software is written does a check to make sure that the CD and key are valid. This check makes sure that the key matches the unique ID. The software retranslates and decrypts the CD key using RSA public key decryption. The result of this transformation is expected to be equal to the SHA-1 hash value of the unique ID/data written to said CD using the uncopyable/error induced sector technique. If this SHA-1 hash value and the decrypted CD key match, then the key and the CD are validated, enabling other software to proceed based on the knowledge that the key and CD are valid.

This method is a secure method for creating unique IDs as a method of copy control. Because the client only knows the public encryption key, no keys can be generated for a unique ID. For each unique ID, there is only one key. There is also only one key for each unique ID. This prevents sharing of the software, as each copy can be identified by its key and rendered unusable.

This implementation meets the cryptographic strength of the copy protection algorithm meet Federal Standard FIPS 140-2 guidelines. At least 128 bits of entropy must be maintained throughout the entire process. There are four steps in the algorithm:
Unique Key Generation—The 256 bit unique key is generated randomly.
SHA-1 Secure Hash—The non-reversible SHA-1 secure hash ensures 160 bits of entropy if the input data is more than 160 bits. Even though the 256 bits of entropy in the input data is reduced to 160 by the hash, it still meets federal guidelines. This assures that the user cannot select the input to the key comparison process.
Binary Software Key—The binary software key is generated by RSA encrypting the hash result using the software distributor's 1024 bit private key. Using a 1024 bit RSA private key ensures 128 bits of entropy. The reverse process, the public key decryption of the of the binary software key also has 128 bits of entropy.
Conversion between text and binary key forms—The text-to-binary conversion does not affect the entropy or the security. It only changes the representation of the data.

This analysis shows that the two cryptographic transformation steps in the algorithm contain retain at least 128 bits entropy to comply with federal standards. Since all keying components are generated randomly there is no loss of entropy in the entire system.

1. A method of creating a digital compact disc, called a CD, that includes uncopyable data for the purpose of protecting software or data by adding consistently detectable errors to the CD for the purpose of writing CD data. The method consists of
a) Digital compact disc optical media able to be read using readers loosely conforming to standards International Electrotechnical Commission document 908 [IEC908] or European Computer Manufacturers Association document 130 [ECMA130], commonly referred to as a “CD-ROM”. Herein this media is referred to as the “CD”.
b) An identifiable set of sectors on said CD where planned errors are potentially to be written. Sectors can be identified by absolute position on the CD, or by relative sectors within a file where the errors are within the start and end sectors of the file or files.
c) The number of uncopyable data bits typically equals the number of said sectors in (b) on said CD. There is a one for one correspondence between the number of uncopyable data bits and said sectors in (b). The ability to read or not read each of the said sectors without reported media (a) represents a bit of digital data, 1 or 0, respectively. Conversely a readable sector could represent a 0 or 1, respectively.
d) There is data or software (content) on said CD whose use is to be protected.
e) Along with said software there is a program which enables extraction or use of the software only when said CD is present.
f) Induced errors in said sectors in (b) are due to physical modifications to the master CD. These physical modifications need only make all the checksum data not match the data written to the data region of the CD. For mode 1 and mode 2 form 1 CDs this would mean CIRC error data as well as sector checksums and P and Q parity bits per [ECMA130] and [IEC908]. For mode 2 form 2 CDs this would only be CIRC error data. Specifically said induced errors are caused by inserting random data in place of checksum data so that 7 or more consecutive frames in a sector are determined by CD readers to be unreadable. The random data is properly EFM [EFM=Eight to Fourteen Modulation] encoded onto said CD media.
g) Sectors where errors are potentially induced are detectable either individually or in clusters by a typical sector-error aware CD-ROM driver. A procedure performs sector based reads of said CD to using the driver to determine which sectors are or are not readable and turns that into digital data for said purposes of creating said CD.

2. Variations in the method of claim 1 such that the form of said induced errors in section (f) of claim 1 in said CD can be by multiple means. These means themselves are not claimed as inventions since they are generally understood by those in the industry, only that the use of any these means for purposefully making sectors uncopyable is claimed. The means of causing errors on CDs includes:
a) The form of the pits can be errently long pits, contain smooth transitions between lands and pits, deeper pits so that there is no phase change in the returned laser light to an optical CD reader, or burned-through or darkened to cause the laser light not to be returned at all.
b) Limits on the area of the physical modifications to said CD in order that said induced errors in each said sector shall not cause tracking errors for optical readers of compact discs (CD). The width of said induced error shall not interfere with or overlap an adjacent track of pits on said CD. Or, if the width of said induced error is wide enough to effect multiple tracks, the length of said induced error in the direction of the track shall not exceed 11 T, where “T” is the constant data spacing interval specific to the compact disc media as defined in [ECMA130] and [IEC908].
c) The density of said induced errors in each said sector in (b) are significant enough to cause a read of said entire sector to fail on all compact disc readers. The minimum number of induced errors required must seven frame errors as defined by [ECMA 130].
Error induction on other optical media has similar methods.

3. Applying the method of claim 1 to optical media other than said CD of part (a) of claim 1. Other optical media will contain sectors and use EFM encoding [EFM] or EFM-like encoding instead. Examples of alternate media include but are not limited to:
a) All DVD Variants including but not limited to DVD-5, DVD-9, DVD-10, DVD-14, DVD 18, DVD-RAM, DVD-R, DVD-RW, DVD+R, DVD+RW, DVD-Audio.
b) All CD Variants including but not limited to CD+I, VCD, SVCD, Photo CD, CD-R, CD-RW.
c) Variants of the above that use alternate reading methods including but not limited to red, green, and blue lasers, such as Blu-Ray.

4. Applying the method of claim 1 for other purposes than creation of making said CD in claim 1 an uncopyable means of media distribution. Such purposes include but are not limited to:
a) Said CD provides only a key to enable access to the data or software, where the software or data protected by said uncopyable CD may not reside on said CD itself but be distributed by other means.
b) Use or features of said software are enabled or restricted by the presence of said CD, however access to the software or data itself is not restricted by said CD.
c) Said CD is used only for identification or validation purposes that may not be specific to any software, software feature, or data.

5. Applying the method of claim 1 to create errors unique to individual CDs. Thus making CDs both uncopyable and unique. Errors can be systematically induced to guarantee uniqueness, or virtually unique by inducing random errors.

6. Use of the method of claim 1 with cryptographic software that utilizes said error-induced data of claim 1 (c). Said data may combine with calculated data associated and possibly distributed with said CD (such as a key written down as human readable text), where the two elements of data are compared to uniquely validate the authenticity of the CD, or provide the key to decrypt or enable the software or data on said CD or associated with said CD.

7. Any combination of the variations in said method of claim 1 as combined with claims 2, 3, 4, 5, and 6.

8. A means of inducing errors causing whole sector error conditions on optical media using non-imaged or stamped techniques, that is where the CD data is sequentially written using lasers while the disk is spinning where the use of high DSV (digital sum variance) data written to CD sectors to cause selected sectors to be written weakly enough to be considered unreadable and therefore containing induced errors on a sector for the purpose of providing one bit of data. That is, if said sector is readable versus unreadable will provide a digital “1” or “0” of data for said purpose of creating said CD.

9. The protection of the content residing on the optical media of claim 1 using a 2 part key security mechanism, one written to the optical media as sector errors, and a second piece of key data distributed using another medium.

10. The inducing of low level errors on physical media that is prone to random read and media errors to result in producing consistently readable sector level errors for the purpose of conveying digital data wholly in terms of the existence or non-existence of such sector level errors where that data is to be used as information. There must be multiple such potentially errored and individually read sectors that are interpreted as information. This claim does not apply to situations where errors are solely to inhibit reading or other standard functional when accessing the content on the physical media.
